(19) United States
(12) Patent Application Publication
(10) Pub. No.: US 2012/0186363 A1
(43) Pub. Date: Jul. 26, 2012

(54) Coriolis Mass Flow Meter

(75) Inventors: Daniel Egner, Ingelfingen (DE); Herbert Schorb, Karlsruhe (DE); Stefan Von Dosky, Karlsruhe (DE)

(73) Assignee: Siemens Aktiengesellschaft, Muenchen (DE)

(21) Appl. No.: 13/390,046

(22) PCT Filed: Aug. 11, 2009
(86) PCT No.: PCT/EP2009/005829

§ 371 Date: Apr. 17, 2012

(51) Int. Cl. G01F 1/84

(52) U.S. Cl. 73/861.357

(57) ABSTRACT

A Coriolis mass flow measuring device, comprising at least one measurement pipe, through which a medium flows and which is induced to vibrate by an exciter arrangement, wherein two optical vibration sensors, arranged before and after the exciter arrangement in the longitudinal direction of the at least one measurement pipe, provide vibration signals, based on which an activation and evaluation device determines the mass flow and/or the density of the medium. The optical vibration sensors each have a pair of superimposed grids having periodic structures to improve the resolution that can be achieved by the optical vibration sensors.

### CROSS-REFERENCE TO RELATED APPLICATIONS

This is a U.S. national stage of application No. PCT/EP2009/005829 filed 11 Aug. 2009.

### BACKGROUND OF THE INVENTION

1. Field of the Invention

The present invention relates to a Coriolis mass flow meter with at least one measuring tube, which is flowed through by a medium and such mass flow meters which can particularly be used in as field devices for process instrumentation;

2. Description of the Related Art

In process engineering installations, a variety of field devices for the process instrumentation are used to control processes. Measuring transducers serve for recording process variables, such as the temperature, pressure, filling level, mass flow, density or gas concentration of a medium. Final control elements allow the process sequence to be influenced in accordance with recorded process variables based on a strategy that is, for example, prescribed by a control station. A control valve, a heater or a pump may be mentioned as examples of final control elements. Particularly in process engineering installations, measuring transducers represent important sensory components for the mass flow. Optimal behavior of the installation and a consistently high product quality necessitate high quality measuring transducers that produce measured values with long-term stability and a low error rate even under extreme conditions.

Coriolis mass flow meters generally have a single measuring tube or a number of measuring tubes, for example, a pair, through which a medium flows, for example, a fluid, of which the mass flow is to be determined. Various arrangements and geometries of the measuring tubes are known for accomplishing this.

There are, for example, Coriolis mass flow meters with a single straight measuring tube and Coriolis mass flow meters with two curved measuring tubes running parallel to one another. The Coriolis mass flow meters with two curved measuring tubes running parallel to one another, formed identically as a pair, are induced by an excitation system placed in the middle region to vibrate such that they oscillate in opposition to one another, i.e., the vibrations of the two measuring tubes are phase-offset with respect to one another by 180°, to achieve a mass equalization. The position of the center of mass of the system formed by the two measuring tubes thereby remains substantially constant and forces occurring are largely compensated. As a positive consequence, this has the result that the vibrating system has scarcely any external effect as such. Provided upstream and downstream of the excitation system are vibration pickups, between the output signals of which a phase difference occurs when there is a flow. This is caused by the Coriolis forces prevailing when there is a flow, and consequently by the mass flow. The density of the medium influences the resonant frequency of the vibrating system. Consequently, apart from the mass flow, it is also possible to determine, inter alia, the density of the flowing medium.

EP 0 874 975 B1 discloses a Coriolis mass flow meter in which coils known as plunger coils are used as vibration pickups. For this purpose, a coil is secured to a frame of the meter and a magnet is secured to a measuring tube. When there are vibrations of the measuring tube, the depth to which the magnet plunges into the coil changes and a voltage is induced in the coil as a measuring signal. The measuring tube vibrations and the mass flow have the effect of generating, at the vibration pickups, two substantially sinusoidal signals which have a small phase shift with respect to one another. An evaluating device determines the respective phase difference and calculates from the mass flow from this phase difference. Particularly in an aggressive environment, electromagnetic interference fields may falsify the measuring signal and thereby influence the measurement. Interferences superposed on the measuring signals make it more difficult to calculate accurate measured values.

A further problem is the desire for smaller Coriolis mass flow meters. This desirability stems for the fact that the shorter the vibrating measuring tube is made and the less it is bent, the smaller the pressure loss of a medium flowing through the meter. At the same time, however, the vibrational amplitude of the measuring tube is reduced, and therefore vibration pickups that allow a higher measured value resolution with a simultaneous smaller standard deviation of the measured values are required.

As an alternative to the known plunger coils, a variety of optical vibration pickups have already been described. For example, EP 1 700 086 A2 describes a vibration pickup for a Coriolis mass flow meter that comprises an optical emitter, a collector and what is known as a light pipe. The open cross section of the light pipe, and consequently also the transmitted luminous flux, are changed in accordance with the vibrations of the measuring tube in the manner of an optical shutter. Here, it is desirable to obtain a linear dependence of the received luminous flux on the position of the measuring tube. U.S. Pat. No. 5,020,380 shows a vibration pickup with an emitter, a fiber and a collector. In this case, the intensity of the transmitted or reflected light changes with the vibrations of the tube. A further construction of a vibration pickup with an emitter, a fiber and a collector is described in U.S. Pat. No. 5,038,620. When there are vibrations of the measuring tube, the fiber becomes curved. With the changing bending radius of the fiber, the intensity of the luminous flux coupled out at the fiber also varies and is detected as a measuring signal. U.S. Pat. No. 6,722,209 B1 shows a Coriolis mass flow meter in which the measuring tube vibrations are recorded by a Fabry-Perot interferometer. In U.S. Pat. No. 6,805,013 B2, reference is made to a large number of physical principles of vibration measurement for Coriolis mass flow meters, but these are not described in further detail.

### SUMMARY OF THE INVENTION

It is an object of the invention to provide a Coriolis mass flow meter including vibration pickups having an improved resolution and which nevertheless is produced comparatively simply.

This and other objects and advantages are achieved in accordance with the invention by a Coriolis mass flow meter comprising at least one measuring tube, which is flowed through by a medium, at least one excitation system, which is arranged in the middle region of the at least one measuring tube and induces vibrations thereof, and an evaluating device, which is configured to activate the at least one excitation system and to receive vibration signals from the at least two vibration pickups. Consequently, the at least one excitation system acts as an actuator to make the at least one measuring tube vibrate. The vibration signals recorded by the vibration pickups are then passed on as measuring signals to the evaluating device. Here, the at least two vibration pickups are arranged upstream and downstream of the at least one excitation system in the longitudinal direction of the at least one measuring tube. The at least two vibration pickups are preferably arranged symmetrically, so that they are at the same distance from the excitation system in the longitudinal direction of the at least one measuring tube. The at least two optical vibration pickups each have a pair of superjacent optical grids, which may be identically formed. Due to mutually corresponding periodic structures of the two grids, when they are transilluminated there is a position-dependent change in the light intensity. When the at least one measuring tube vibrates, a luminous flux passing through the grids is changed repeatedly in its intensity and vibration signals with variable frequency are obtained, on average a multiple of the frequency of the mechanical vibrations of the measuring tube. For this purpose, the distance between the periodic structures in the grids is only a fraction of the vibrational amplitude of the at least one measuring tube. It should be understood that frequency ratios are not restricted to integral factors.

It should also be understood that a light source is required for generating the luminous flux and a light sensor is required for receiving the luminous flux influenced by the grids. The source and sensor may be arranged opposite one another, i.e., on different sides of the two grids, or on the same side when the source and sensor are arranged on different sides of the two grids. In the latter case, a mirror is on the opposite side and the luminous flux reflected back can be coupled out, for example, aided by a beam splitter arranged in the path of rays between the light source and the grids. The function of the mirror and the grid nearest to the mirror can in this case be fulfilled, in a simplified form, by a correspondingly structured mirror. Furthermore, it is possible in the first-mentioned case to fulfil the function of the light source and of the grid nearest to the light source by suitable structuring of the light-exiting area of the light source with a single component, and/or that the function of the other grid, respectively, is assumed by a correspondingly structured light-entering area of the light sensor.

In comparison with the conventional practice of providing a Coriolis mass flow meter with plunger coils as vibration pickups, the optical vibration pickups in accordance with the invention have the advantage that they are much less sensitive to external electromagnetic interferences and that they have a greater sensitivity with respect to the deflection of the measuring tube. This is because, on account of the changing of the light intensity with a variable frequency that is dependent on the velocity of the tube at a particular time and is on average much higher than the frequency of the vibrations of the at least one measuring tube, a higher resolution is achieved with respect to the position of the measuring tube, and consequently with respect to the phase position of the measuring tube vibration. The Coriolis mass flow meter in accordance with the invention also responds quickly to changes in the mass flow, and current measured values can be determined more quickly. This is of particular advantage in the case of highly dynamic metering operations, in which the mass flow can change very quickly. A further advantage can be seen in an improvement in the signal-to-noise ratio with respect to low-frequency process vibrations that can be coupled into the meter via pipelines, due to the use of a measuring signal of higher frequency.

Since a contactless measuring method is involved, no wires or lines that could influence the vibrations of the measuring tube or become detached from it over a prolonged operating time have to be secured to the tube. The optical grid that is coupled to the at least one measuring tube can be realized with a very small dead weight, so that its effects on the vibrational properties of the measuring tube are minimal. It is also advantageous that the optical vibration pickups can be realized with a comparatively small type of construction, and consequently can also be used in Coriolis mass flow meters with a small housing. In particular, no attachments of any great size are required on the measuring tube. On account of the improved resolution of the vibration pickups, a phase difference can be detected even with relatively small vibrational amplitudes. It is therefore possible to operate the Coriolis mass flow meter with a smaller vibrational amplitude, and consequently to reduce the power consumption of the excitation system.

A particularly clear change in intensity in the case of vibrations, and consequently a good signal quality of the luminous flux passing through the grids, can be achieved if devices for limiting the expansion of the beam are provided upstream of the pair of superjacent grids. In this way, a luminous flux with little expansion of the beam can be directed substantially perpendicularly onto the superjacent grids.

An embodiment which has proven to be particularly advantageous is one in which the superjacent grids are realized by two optical line grids aligned substantially parallel to one another. With lines running perpendicularly to the direction of vibration of the at least one measuring tube, clear fluctuations in the brightness of the transmitted light can be detected. Brightness modulations occur as a moire effect, for example, when the grid constants of the optical line grids deviate minimally from one another or if line grids that have the same grid constant but are turned slightly with respect to one another are used. Consequently, in this case the displacement of the grids in relation to one another can also be determined with greater accuracy.

A luminous flux with little beam expansion can be obtained particularly simply by an aperture diaphragm being arranged upstream of the superjacent grids.

For directing the light to the superjacent grids and for recording the luminous flux transmitted through the grids, light-conducting fibers may be used in the optical vibration pickups. It is thereby possible to advantageously operate two or more optical vibration pickups with a single light source. Furthermore, this has the advantage that the light source and the light receiver, which represent comparatively sensitive components, can be arranged at a greater distance from the measuring tube. In particular, when the mass flow meter is used with hot process media, this has an advantageous effect on the robustness of the vibration pickups. When light-conducting fibers are used, it is possible to dispense with the aperture diaphragm upstream of the superjacent grids, because the light-exiting cross section of the fibers is already comparatively small.

It should also be understood that the superjacent optical grids have periodic structures that not only correspond to one another but are completely identically formed. If the two grids are displaced with respect to one another by an extent that corresponds to the periodicity of the structures, in this case the intensity of the luminous flux passing through the grids likewise completes precisely one period. For the light receiver, it is sufficient to use a simple photodetector, upstream of which an aperture diaphragm may be arranged. The spatial periodicity of the structures is chosen to be many times less than the vibrational amplitude of the at least one measuring tube. Also when a number of vibrating measuring tubes are used in a Coriolis mass flow meter, it may be of advantage to secure the other grid, respectively, of the pair of superjacent grids to a frame of the Coriolis mass flow meter. In the case of this embodiment, it is possible to determine for each measuring tube separate measured values of the position thereof with respect to the frame of the meter. Apart from the actual measuring signal, it is consequently possible to ascertain further information, concerning the meter or the state of flow of the measuring medium, that is useful, for example, for diagnosis.

When using at least one pair of measuring tubes arranged substantially parallel to one another that vibrate with a phase position offset by 180° with respect to one another for mass equalization, a particularly simple construction of the vibration pickups is obtained, however, if the other grid, respectively, of the pairs of superjacent grids is secured to the other measuring tube, respectively, of the pair of measuring tubes arranged parallel to one another. This makes it possible for the conventional vibration pickups which, for example, operate with the known magnetic plunger coils, to be simply substituted by the novel optical vibration pickups. Such an embodiment is particularly simple.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Refinements and advantages are explained in more detail on the basis of the drawings, in which an exemplary embodiment of the invention is represented, and in which:

FIG. 1 shows an exemplary embodiment of a Coriolis mass flow meter;

FIG. 2 schematically shows the exemplary construction of an optical vibration pickup; and

FIG. 3 shows a graphical plot of the variations over time of a measuring signal and of a position of a tube.

### DETAILED DESCRIPTION OF THE PREFERRED EMBODIMENTS

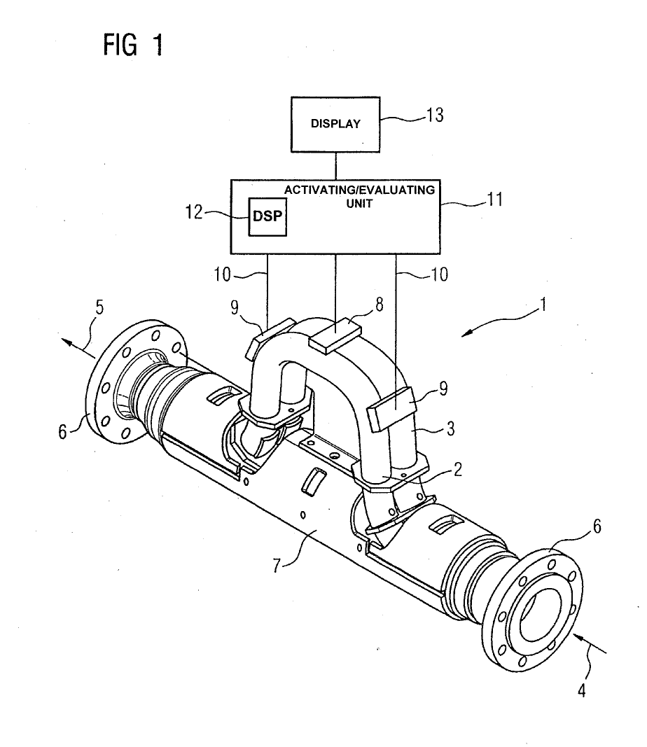

FIG. 1 shows a Coriolis mass flow meter 1 according to a preferred exemplary embodiment of the present invention. The mass flow meter 1 has a first measuring tube 2 and a second measuring tube 3, which are arranged substantially parallel to one another. These are usually made from one piece by bending. The path followed by the measuring tubes 2 and 3 is substantially U-shaped. A flowable medium flows according to an arrow 4 into the mass flow meter 1, and thereby into the two inlet portions of the measuring tubes 2 and 3 located downstream of an inlet splitter, which cannot be seen in FIG. 1, and according to an arrow 5 out again from the outlet portions and the outlet splitter located downstream thereof, which likewise cannot be seen in FIG. 1. Flanges 6, which are fixedly connected to the inlet splitter and the outlet splitter, serve for securing the mass flow meter 1 in a pipeline not represented in FIG. 1. The geometry of the measuring tubes 2 and 3 is kept largely constant by a stiffening frame 7, so that even changes of the pipeline system in which the mass flow meter 1 is fitted, for example, caused by temperature fluctuations, lead at most to a minor shift of the zero point. An excitation system 8, which is schematically represented in FIG. 1 and may comprise, for example, a magnetic coil that is located on the measuring tube 2 and a magnet that is attached to the measuring tube 3 and plunges into the magnetic coil, serves for generating mutually opposed vibrations of the two measuring tubes 2 and 3, the frequency of which corresponds to the natural frequency of the substantially U-shaped middle portion of the measuring tubes 2 and 3.

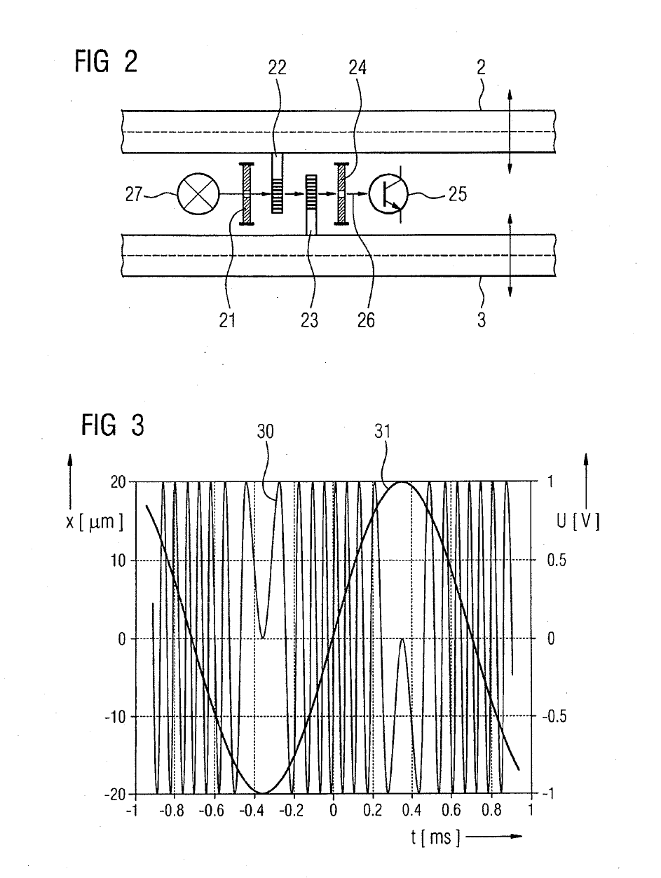

Optical vibration pickups 9 represented schematically in FIG. 1 serve for recording the Coriolis forces and/or the vibrations of the measuring tubes 2 and 3, which are caused by the Coriolis forces and occur on account of the mass of the medium flowing through. A possible construction of the vibration pickups 9 will also be explained in more detail later on the basis of FIG. 2. The vibration signals 10, which according to FIG. 1 are generated by the vibration pickups 9, are evaluated by an activating and evaluating device 11. For the evaluation, the activating and evaluating device 11 comprises a digital signal processor 12. Results of the evaluation are output on a display 13 or are transmitted to a higher-level control station via an output not represented in FIG. 1, such as a field bus. Apart from the evaluation of the vibration signals 10, in the exemplary embodiment represented, the activating and evaluating device 11 also undertakes the activation of the excitation system 8.

As a departure from the exemplary embodiment represented, the two vibration pickups 9, which here record the relative position of the measuring tubes 2 and 3 in relation to one another, may alternatively be configured such that the relative position of a measuring tube 2 or 3 with respect to the stiffening frame 7 is respectively recorded. In the case of an exemplary embodiment with two vibrating measuring tubes, however, four optical vibration pickups are then required. Furthermore, as a departure from the exemplary embodiment represented, it should be understood that the measuring tubes 2 and 3 may have different geometries, for example, a straight, V-shaped or Ω-shaped middle portion, or a different number and arrangement of excitation systems and optical vibration pickups may be chosen. The Coriolis mass flow meter may alternatively have a different number of measuring tubes, for example, one measuring tube or more than two measuring tubes.

In the exemplary embodiment of an optical vibration pickup according to FIG. 2, a first aperture diaphragm 21, a first grid 22, with periodic structures, a second grid 23, likewise with periodic structures, a second aperture diaphragm 24 and a photodetector 25 are arranged one behind the other in the path of rays of a luminous flux 26, which is generated by a light source 27. The first grid 22 is secured to the first measuring tube 2, the second grid 23 is secured to the second measuring tube 3. If the two measuring tubes 2 and 3 vibrate in opposition to one another, i.e., with a vibration phase-shifted by 180°, the two grids 22 and 23 superjacent one another in the path of rays are displaced in relation to one another. The periodic structures of the grids 22 and 23 are optical line grids, the lines of which run perpendicularly in relation to the plane of the drawing. In the exemplary embodiment, the lines of the first grid 22 are aligned parallel to the lines of the second grid 23. The distance between lines that are next to one another is the same in the two grids 22 and 23. It is smaller than the vibration amplitude of the two measuring tubes 2 and 3 by a multiple, for example, by a factor of 10. However, the distance is chosen to be large enough that, at the optical wavelength of the light source 27, the influence of light diffraction effects at the grids 22 and 23 on the intensity of the light received by the photodetector 25 is still negligible. The light source 27, which may be configured as an LED or semiconductor laser, emits a luminous flux, which is concentrated by the first aperture diaphragm 21. The luminous flux which impinges on the first grid 22 therefore has little beam expansion. In the translucent regions of the first grid 22, part of the luminous flux is allowed through, so that it impinges on the second grid 23 located behind the first. If the translucent regions of the second grid 23 are precisely congruent with the translucent regions of the grid 22, the incoming luminous flux will pass the second grid 23 almost unattenuated. The part of the luminous flux originally emitted by the light source 27 that arrives at the photodetector 25 then has the maximum intensity. If, on the other hand, the two grids 22 and 23 are positioned precisely in relation to one another such that the luminous flux that has passed the first grid 22 impinges on opaque regions of the second grid 22, only a minimal part of the luminous flux arrives at the photodetector 25, and the measuring signal output by the latter has precisely its minimum level. Since the distance between the periodic structures on the grids 22 and 23 is chosen to be much smaller than the vibration amplitude of the two measuring tubes and 3, the luminous flux that is received by the photodetector 25 has a variable frequency, which on average is a multiple of the frequency of the vibrations of the measuring tubes 2 and 3. This effect is explained in more detail hereafter based on FIG. 3.

In FIG. 3, a variation 30 of a vibration signal that is output by a photodetector in an optical vibration pickup according to FIG. 2 is represented over time by way of example. The time t in milliseconds is indicated on the x axis, the position of a tube x in micrometers is indicated on the left-hand y axis and the voltage level U of the vibration signal in volts is indicated on the right-hand y axis. The voltage signal generated with the aid of the photodetector corresponds to the intensity of the luminous flux 26 (FIG. 2) impinging on the photodetector 25 (FIG. 2). On account of the periodic structures in the grids 22 and 23 (FIG. 2), when there are vibrations of the measuring tubes 2 and 3 (FIG. 2) this intensity is dependent on the position of a tube at a particular time. In addition to the variation 30 of the vibration signal, a variation 31 of the position of a tube is depicted in FIG. 3. To make it clearer, DC components of the signal have been removed from the variations 30 and 31 represented. If an optical vibration pickup is used, the basic construction of which has been explained in more detail with reference to FIG. 2, the variation 30 of the vibration signal has a considerably greater number of zero transitions than the variation 31 of the position of a tube. In the time domain there is thus advantageously much greater detailing of the vibration signal, which is achieved with the novel optical vibration pickup. The points of inflection of the position of a tube, at which the maximum values of the variation 31 are achieved, are distinguished by a locally minimum frequency of the vibration signal in accordance with the variation 30. At the zero transitions of the variation 31, at which the measuring tubes are moving at the maximum speed, local maxima of the frequency of the vibration signal can be seen well. Consequently, in the case of a Coriolis mass flow meter that is provided with the optical vibration pickups in accordance with the invention, not only an evaluation of the vibration signals in the time domain but also an evaluation of the vibration signals in the frequency domain is possible for determining the mass flow or the density of the medium. In a simple way, the fundamental frequency of the variation 31, and with it the density of the medium, can be concluded based on the variation 30, and similarly the phase shift of the vibrations of the two measuring tubes, and with it the mass flow, can be concluded based on the variation 30 and a further variation that has been recorded by the second optical vibration pickup of the Coriolis mass flow meter.

The optical vibration pickup explained based on FIG. 2 can replace conventional magnetic vibration pickups with magnetic plunger coils in a particularly simple way. In order to achieve a robust configuration, the light source and the photodetector are preferably secured to the frame of the Coriolis mass flow meter. As a result, no electrical leads have to be attached to the measuring tubes. The use of a common light source for a number of optical vibration pickups is possible, for example, by the light being fed to the various pairs of superjacent optical grids through light-conducting fibers. In the case of such a configuration, the sensitive light source and the photodetector are arranged at a greater distance from the measuring tubes, which under some circumstances are at a high temperature. This further improves the robustness of the meter. Instead of a distance measurement of the two measuring tubes, as shown in FIG. 2, alternatively the change in position of a measuring tube with respect to the frame of the meter may be recorded. For this purpose, only one optical grid is mechanically coupled to the respective measuring tube, while the other optical grid should be secured to the frame. Although this increases the effort involved in realizing the optical vibration pickups, additional information concerning the meter can be ascertained from the vibration signals of the pickups, for example, information useful for diagnosis or information concerning the state of the medium, such as for the detection of a multiphase flow.

In the exemplary embodiment explained based on FIG. 2, identical optical grids have been used in the vibration pickup. As an alternative, the optical grids may deviate slightly from one another, for example, with respect to the distance of the lines from one another or with respect to the inclination of the lines, producing patterns known as moire patterns in the luminous flux downstream of the second optical grid. Although a photodetector can also be used in this case as the light receiver, the use of an image sensor lends itself to the detection of moire patterns, because a very accurate determination of the relative position of the grids in relation to one another is also possible from the patterns depicted.

An alternative to securing the first optical grid directly to the at least one measuring tube is a mechanical coupling by way of a lever mechanism or a gear mechanism, so that the movement of the measuring tube is converted into a translatory or rotary movement of the optical grid.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-7. (canceled)

8. A Coriolis mass flow meter, with comprising:
at least one measuring tube through which a medium flows;
at least one excitation system arranged in a middle region of the at least one measuring tube to induce vibrations in the at least one measuring tube;
at least two optical vibration pickups arranged upstream and downstream of the at least one excitation system in a longitudinal direction of the at least one measuring tube; and
an activating and evaluating device configured to activate the at least one excitation system, to receive vibration signals from the at least two vibration pickups, and to determine at least one of a mass flow and density of the medium based on the vibration signals;
wherein the at least two optical vibration pickups each include a pair of superjacent grids having periodic structures corresponding to one another, of which at least one superjacent grid is mechanically coupled to the at least one measuring tube to displace the periodic structures in relation to one another when the vibrations are present, such that an intensity of a luminous flux influenced by the pair of superjacent grids has a variable frequency, which on average is a multiple of a frequency of the vibrations of the at least one measuring tube.

9. The Coriolis mass flow meter as claimed in claim 8, further comprising:
a first device and a second device for generating a luminous flux directed with minimal expansion of a beam substantially perpendicularly onto the pair of superjacent grids.

10. The Coriolis mass flow meter as claimed in claim 8, wherein the pair of superjacent grids comprise optical line grids aligned substantially parallel to one another.

11. The Coriolis mass flow meter as claimed in claim 9, wherein the pair of superjacent grids comprise optical line grids aligned substantially parallel to one another.

12. The Coriolis mass flow meter as claimed in claim 9, wherein the first device and the second device for generating the luminous flux comprise a light source and an aperture diaphragm, respectively, the first and second devices being arranged upstream of the pair superjacent grids.

13. The Coriolis mass flow meter as claimed in claim 11, wherein the first device and the second device for generating the luminous flux comprise a light source and an aperture diaphragm, respectively, the first and second devices being arranged upstream of the pair superjacent grids.

14. The Coriolis mass flow meter as claimed claim 8, further comprising:
light-conducting fibers configured to at least one of conduct the luminous flux to the pair of superjacent grids and record the luminous flux transmitted through the pair of superjacent grids.

15. The Coriolis mass flow meter as claimed in claim 8, wherein the other grid, respectively, of the pairs of superjacent grids is secured to a frame of the Coriolis mass flow meter.

16. The Coriolis mass flow meter as claimed in claim 8, wherein the at least one measuring tube comprises a pair of measuring tubes arranged substantially parallel to one another;
wherein at least one grid, respectively, of the pairs of superjacent grids is secured to one measuring tube of the pair of measuring tubes arranged parallel to one another; and
wherein another grid, respectively, of the pairs of superjacent grids is secured to the other measuring tube, respectively, of the pair of measuring tubes arranged parallel to one another.
